(19) United States
(12) Patent Application Publication
(10) Pub. No.: US 2025/0353504 A1
(43) Pub. Date: Nov. 20, 2025

(54) VEHICULAR DRIVING ASSIST SYSTEM WITH TRAFFIC JAM PROBABILITY DETERMINATION

(71) Applicant: Magna Electronics Inc., Auburn Hills, MI (US)

(72) Inventors: Jigneshkumar Natvarlal Vasoya, Brampton (CA); Kirti Hiranand Balani, Maharashtra (IN); Vishalkumar Madhusudan Mehta, Gujarat (IN); Pushpendra Kushwaha, Rochester Hills, MI (US)

(21) Appl. No.: 19/280,177

(22) Filed: Jul. 25, 2025

Related U.S. Application Data
(63) Continuation of application No. 16/947,867, filed on Aug. 21, 2020, now Pat. No. 12,371,027.
(60) Provisional application No. 62/890,708, filed on Aug. 23, 2019.

(51) Int. Cl. B60W 40/04; G06N 7/00; G08G 1/01

(52) U.S. Cl. CPC B60W 40/04; G06N 7/00; G08G 1/0133; B60W 2420/403; B60W 2420/408; B60W 2552/05; B60W 2552/10; B60W 2554/406; B60W 2554/408

(57) ABSTRACT

A vehicular driving assist system includes a forward-viewing camera disposed at a vehicle and viewing at least forward of the vehicle through a windshield of the vehicle. With the vehicle traveling along a traffic lane of a multi-lane road, the system, based at least in part on processing of image data captured by the forward-viewing camera, determines traffic attributes for the traffic lane along which the equipped vehicle is traveling and at least one adjacent traffic lane of the multi-lane road that is adjacent to the traffic lane along which the vehicle is traveling. The system determines traffic jam probability for each respective traffic lane of the multi-lane road based at least in part on the determined traffic attributes. Based on the determined traffic jam probability for each respective traffic lane of the multi-lane road, the traffic lane that has the lowest determined respective traffic jam probability may be determined.

### CROSS REFERENCE TO RELATED APPLICATIONS

The present application is a continuation of U.S. patent application Ser. No. 16/947,867, filed Aug. 21, 2020, now U.S. Pat. No. 12,371,027, which claims the filing benefits of U.S. provisional application Ser. No. 62/890,708, filed Aug. 23, 2019, which is hereby incorporated herein by reference in its entirety.

### FIELD OF THE INVENTION

The present invention relates generally to a vehicle vision system for a vehicle and, more particularly, to a vehicle vision system that utilizes one or more cameras at a vehicle.

### BACKGROUND OF THE INVENTION

Use of imaging sensors in vehicle imaging systems is common and known. Examples of such known systems are described in U.S. Pat. Nos. 5,949,331; 5,670,935 and/or 5,550,677, which are hereby incorporated herein by reference in their entireties.

### SUMMARY OF THE INVENTION

The present invention provides a driver assistance system or vision system or imaging system for a vehicle that utilizes one or more sensors (e.g., one or more CMOS cameras, one or more radar sensors, one or more lidar sensors, etc.) to capture sensor data from exterior of the vehicle, and provides an ECU including electronic circuitry and associated software. The circuitry of the ECU includes a data processor for processing sensor data captured by the at least one sensor to detect presence of objects in the field of sensing of the sensor, and the ECU, responsive to processing by the data processor at the control of sensor data captured by the sensor, determines traffic attributes for each traffic lane of a plurality of traffic lanes of a road the vehicle is travelling along. Responsive to determining the traffic attributes, the ECU determines a predicted traffic value based on the traffic attributes and an output from a trained prediction model. Responsive to determining the predicted traffic value, the ECU determines a traffic jam probability for each traffic lane ahead of the road ahead of the equipped vehicle based on the predicted traffic value and the respective traffic attributes.

These and other objects, advantages, purposes and features of the present invention will become apparent upon review of the following specification in conjunction with the drawings.

### BRIEF DESCRIPTION OF THE DRAWINGS

FIG. 1 is a plan view of a vehicle with a vision system that incorporates cameras in accordance with the present invention;

FIG. 2 is a table of permutations for traffic jam probability;

FIG. 3 is a table of exemplary prediction model coefficients; and

FIG. 4 is a table of exemplary traffic scenario and environmental testing parameters.

### DESCRIPTION OF THE PREFERRED EMBODIMENTS

A vehicle vision system and/or driver assist system and/or alert system operates to capture images exterior of the vehicle and may process the captured image data to display images and to detect objects at or near the vehicle and in the predicted path of the vehicle, such as to assist a driver of the vehicle in maneuvering the vehicle in a rearward direction. The vision system includes an image processor or image processing system that is operable to receive image data from one or more cameras (or other non-imaging sensors such as radar sensors and/or lidar sensors) and provide an output to a display device for displaying images representative of the captured image data.

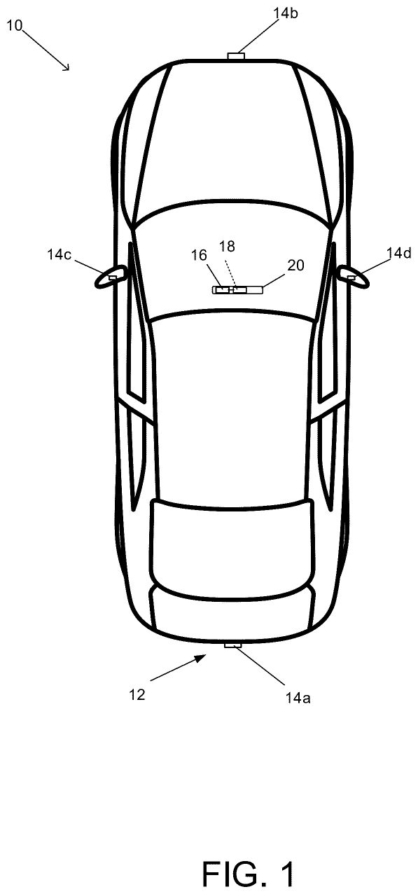

Referring now to the drawings and the illustrative embodiments depicted therein, a vehicle 10 includes an imaging system or vision system 12 that includes at least one exterior viewing imaging sensor or camera (e.g., one or more radar sensors, one or more lidar sensors, etc.), such as a rearward viewing imaging sensor or camera 14a (and the system may optionally include multiple exterior viewing imaging sensors or cameras, such as a forward viewing camera 14b at the front (or at the windshield) of the vehicle, and a sideward/rearward viewing camera 14c , 14d at respective sides of the vehicle), which captures images exterior of the vehicle, with the camera having a lens for focusing images at or onto an imaging array or imaging plane or imager of the camera (FIG. 1). Optionally, a forward viewing camera may be disposed at the windshield of the vehicle and view through the windshield and forward of the vehicle, such as for a machine vision system (such as for traffic sign recognition, headlamp control, pedestrian detection, collision avoidance, lane marker detection and/or the like). The vision system 12 includes a control or electronic control unit (ECU) 18 that includes electronic circuitry and associated software, with the electronic circuitry including a data processor that is operable to process image data captured by the camera or cameras (or to process sensor data captured by a non-imaging sensor, such as a radar sensor or lidar sensor or the like) and may detect objects or the like and/or provide displayed images at a display device 16 for viewing by the driver of the vehicle (although shown in FIG. 1 as being part of or incorporated in or at an interior rearview mirror assembly 20 of the vehicle, the control and/or the display device may be disposed elsewhere at or in the vehicle). The data transfer or signal communication from the camera to the ECU may comprise any suitable data or communication link, such as a vehicle network bus or the like of the equipped vehicle.

Traffic congestion is a major issue that many metropolises face. Traffic congestion wastes time and energy, causes pollution and stress, decreases productivity and imposes costs on society. Factors such as accidents, vehicle breakdowns, improper synchronized traffic signals, special events (e.g., social gatherings, sporting events, rallies, etc.), bad weather conditions, etc. cause a variety of traffic congestion scenarios.

Various features of autonomous vehicles or semi-autonomous vehicles (i.e., vehicles capable of at least partially controlling driving functions such as steering, braking, and acceleration) are used to detect various traffic scenarios and to alert, assist and facilitate a driver and/or passenger of the vehicle and potentially aid in making a vehicle semi or fully autonomous.

Traffic jams are often very frustrating and painful for drivers. By measuring traffic jam probability and feeding the measurement to features of the autonomous or semi-autonomous vehicle such as adaptive cruise control (ACC) and/or lane keep/change assist or other driver assistance systems, user convenience and safety along with vehicle productivity (e.g., fuel economy) may be improved.

Systems and methods of the present invention determine real-time traffic jam probability using at least one front or forward sensing sensor (e.g. a radar sensor and/or a lidar sensor and/or a camera) installed at the vehicle. The system determines or calculates road attributes for each traffic lane of the current road. For example, the system may determine traffic density, traffic flow rate, collective velocity, and longitudinal distance between the host vehicle and a target vehicle. These road attributes may accurately describe the traffic on the road along which the equipped vehicle is traveling. The system prepares synthetic data of the determined attributes using subjective opinions of one or more observers (e.g., human annotators) for different possible traffic scenarios. For example, the subjective opinion (i.e., based upon their opinion of traffic in the images and not based on any empirical measurements) of three or more observers may be included. The system, in some implementations, trains a quadratic linear model on the prepared synthetic data and predicts traffic jam probability on a lane-by-lane basis (i.e., a probability of a traffic jam for each lane individually). The system may calculate the overall traffic jam probability by averaging the probability of each traffic lane.

The system, in some implementations, determines the traffic jam probability in three primary steps. In one step, the system calculates traffic attributes for each traffic lane. For example, traffic may be measured by number of objects (i.e., other vehicles) ahead of the ego (i.e., host) vehicle (or behind, or around), their speed relative to the ego vehicle, and their distance from ego vehicle. Using these measurements, the system determines different traffic attributes such as traffic density, flow rate, collective velocity, and longitudinal distance between the host vehicle and the object.

For example, the system may determine traffic density Dₖ of an individual lane of a road the vehicle is travelling along using Equation (1), where F_{D} is a normalization factor for density, R is a distance range ahead of the host vehicle, N is the total number of vehicles in a lane within distance range R, and Lᵥ is the length of the vehicle. Traffic density is defined as a measure of total occupied length of vehicles within the distance range R.

$${D}_{k} = ( \frac{{F}_{d}}{R} ) * {\sum }_{v = 1}^{N} {L}_{v} \qquad ( 1 )$$

The system may determine flow rate Fₖ of an individual lane of the road the vehicle is travelling along using Equation (2), where F_{F} is a normalization factor for flow rate and Sv is the speed or velocity of the vehicle. Flow rate is defined as a measure of the number of vehicles able to move a certain distance within a defined time duration (i.e., how quickly the vehicles are moving). The absolute speed of objects (i.e., other vehicles) may be determined using the relative speed of the object to the host vehicle.

$$\begin{matrix}{F}_{k} = {F}_{F} * {\sum }_{v = 1}^{N} f ( {S}_{v} ) & Where f ( {S}_{v} ) = \{ \begin{matrix}1 , {S}_{v} \geq 10 \\ 0 , {S}_{v} < 10\end{matrix}\end{matrix} \qquad ( 2 )$$

The system may determine a collective velocity Vk of the vehicles on an individual lane of the road the vehicle is travelling along using Equation (3), where Fᵥ is a normalization factor for velocity. Collective velocity is defined as a measure of the average absolute velocity of all vehicles within the range R of the host vehicle.

$${V}_{k} = ( \frac{1}{{F}_{v}} ) * ( \frac{1}{N} ) * {\sum }_{v = 1}^{N} {S}_{v} \qquad ( 3 )$$

The system may determine a normalized longitudinal distance Lₖ, where Dᵥ is the longitudinal distance or length of the host vehicle. Normalized longitudinal distance is defined as the ratio of minimum longitudinal distance to distance range R.

$$\begin{matrix}{L}_{k} = ( \frac{1}{R} ) * MIN [ {D}_{v} ] & Where v = 1 to N\end{matrix} \qquad ( 4 )$$

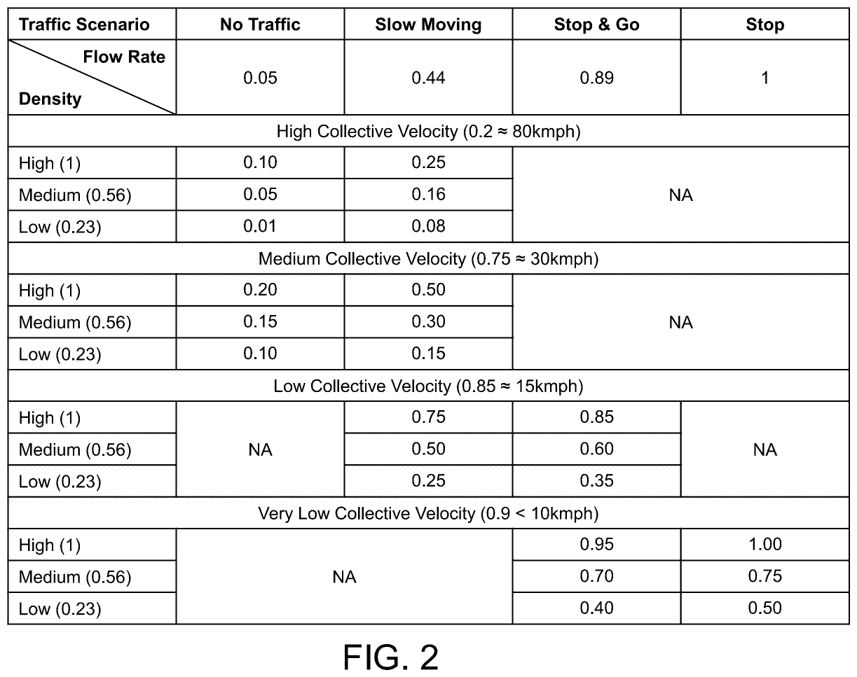

In another step, the system generates a linear regression prediction model. The system generates the model, in some examples, through data annotation and model training. During the data annotation phase, a training dataset is prepared and categorized into different possible traffic scenarios. For example, traffic categories may include “no traffic”, “slow moving”, “stop and go”, and “stop/halt”. A ccontributing probability of a traffic jam for considered attributes is categorized as “High”, “Medium”, “Low” & “Very low” as illustrated in FIG. 2. The table of FIG. 2 represents corresponding traffic jam probability for possible permutations of the considered attributes using the subjective opinion of three different observers. That is, three human reviewers reviewed the test images and, using their subjective opinion, classified the traffic conditions present in the test images. The opinions of the observers is averaged. Other numbers of observers may be used to classify and/or annotate the test images (e.g., one, five, etc.).

Traffic density is linearly proportional to traffic jam probability while flow rate, collective velocity, and relative longitudinal distance are inversely proportional to traffic jam probability. That is, higher traffic density correlates to higher traffic jam probability while higher flow rate, collective velocity, and relative longitudinal distance correlate to lower traffic jam probability. The system, in some implementations, applies a linear regression technique to train the prediction model during the model training phase. After performing the linear regression technique, the system may perform a data transformation technique. For example, the system achieves data transformation using a three variable quadratic linear equation and model training with weighted least square fitting using QR (Orthogonal-triangular) decomposition algorithm respectively.

A predicted value y may be determined from Equation (5), where x₁ is the traffic density, x₂ is the flow rate, and x₃ is the collective velocity.

$$y = {c}_{0} + {c}_{1} * {x}_{1} + {c}_{2} * {x}_{2} + {c}_{3} * {x}_{3} + {c}_{4} * ( {x}_{1} * {x}_{2} ) + {c}_{5} * ( {x}_{1} * {x}_{3} ) + {c}_{6} * ( {x}_{2} * {x}_{3} ) + {c}_{7} * {x}_{1}^{2} + {c}_{8} * {x}_{2}^{2} + {c}_{9} * {x}_{3}^{2} \qquad ( 5 )$$

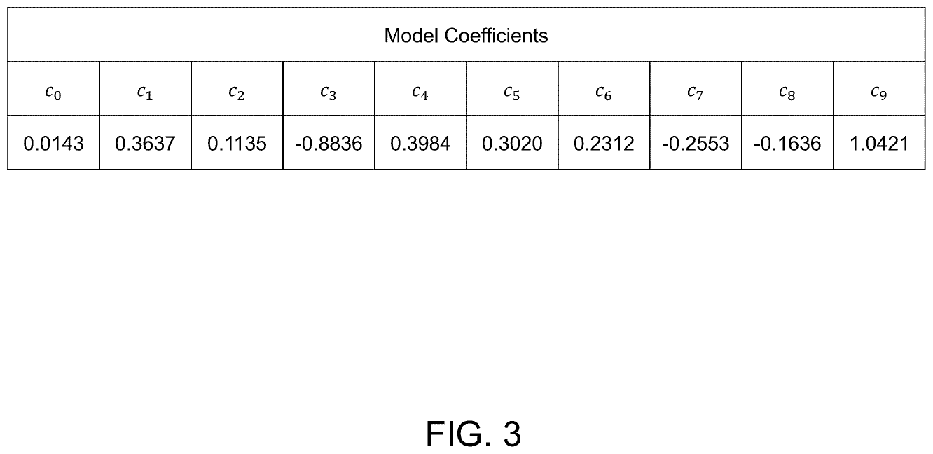

The coefficients (i.e., c₀-c₉) are derived from the trained linear model. In some examples, the coefficients are equal to the values illustrated in FIG. 3. However, other coefficients may be used based on the model.

In another step, the system determines a traffic jam probability P by first determining a traffic jam probability for each individual lane Pₖ in Equation (6), where Pₖ is the traffic jam probability for the kth lane.

$${P}_{k} = ( 1 - {L}_{k} ) * f ( {D}_{k} , {F}_{k} , {V}_{k} ) \qquad ( 6 )$$

The function f(Dₖ, Fₖ, Vₖ) is equivalent to y from Equation (5). That is, the function is equivalent to the predicted output of the trained linear predication model.

After determining the traffic jam probability for each traffic lane, the total traffic jam probability P is determined using Equation (7), where K is the total number of traffic lanes.

$$P = ( \frac{1}{K} ) {\sum }_{k = 1}^{K} {P}_{k} \qquad ( 7 )$$

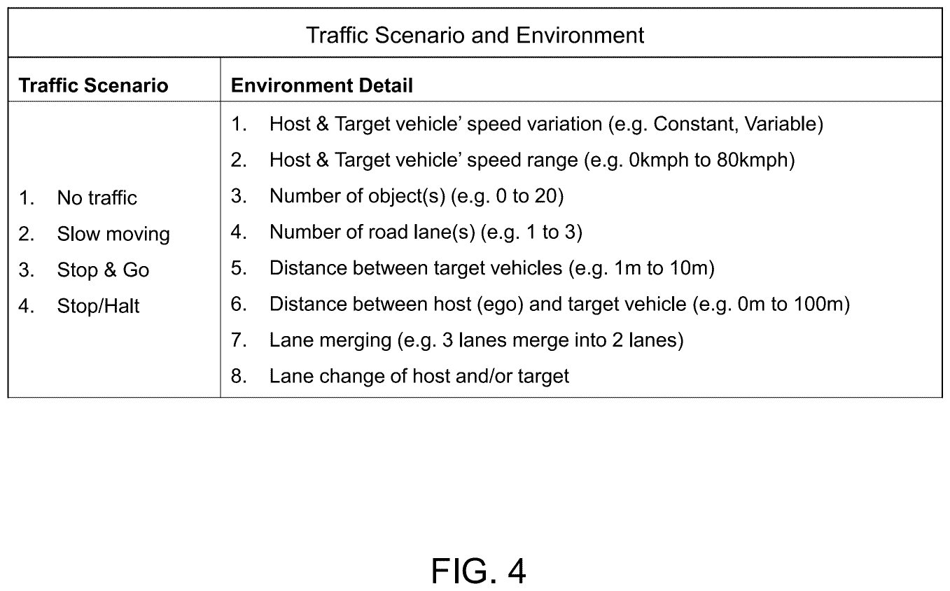

Referring now to FIG. 4, performance measurement conditions are illustrated. For example, a simulation tool for virtual test driving may simulate many (e.g., 25 or more) different possible traffic scenarios. Thus, the system is robust in a variety of traffic scenarios, such as variable speed between host and target vehicles, variable distance between host and target vehicles, variable number of target vehicles, and number of lanes.

Thus, the system determines real-time traffic jam probability using front sensor data (e.g. radar, lidar, and/or camera data) of the ego vehicle. Other target vehicles (i.e., other vehicles on the road) may be considered objects having certain details. The system uses a lane-wise object list that is determined from sensor data pre-processing. The object list includes details of each object (e.g., other vehicles on the road and in the field of sensing of the forward sensing sensor) such as the other vehicle's relative velocity and longitudinal distance with respect to ego vehicle and length of the object or other vehicle. The system, based on the determined traffic information in multiple traffic lanes of the road determines a traffic jam probability (a likelihood of greater traffic density and slow moving or stopped traffic) for each traffic lane, which may be used to select a traffic lane for the vehicle to travel along.

The traffic jam determination generated by the system may be used in a variety of autonomous driving applications, such as adaptive cruise control, lane keeping/change assist, automatic emergency breaking (AEB), vehicle navigation systems, and automated vehicle headlight control (i.e., selection of high/low beams). For example, responsive to determination of a lower traffic jam probability in a particular traffic lane (that is lower than the determined traffic jam probability in the traffic lane in which the vehicle is being driven), the autonomous driving system may maneuver the vehicle into that particular traffic lane to avoid the possible traffic jam (or to avoid a greater traffic jam) that may occur in the other traffic lane or traffic lanes. Optionally, the system may generate an output to a driver or occupant of the vehicle (such as via a display screen in the vehicle that is viewable by the driver) to alert the driver or occupant as to which traffic lane has the lower or lowest traffic jam probability (whereby the driver or occupant can control the vehicle to maneuver the vehicle into that traffic lane).

The system may communicate with other vehicles or infrastructure via, for example, a vehicle-to-vehicle or vehicle-to-infrastructure communication system. The system may communicate traffic parameters or traffic jam probability to other vehicles or infrastructure. For example, the system may provide traffic data and/or traffic jam probabilities to other vehicles travelling behind the vehicle to provide additional notice to the other vehicles. Likewise, the system may receive traffic data and/or traffic parameters and/or traffic jam probabilities from systems of other vehicles and may adjust the determination of the traffic jam probability appropriately. For example, the system may determine the traffic jam probability of each traffic lane (and/or of the road) ahead of the vehicle based in part on the communications (including either traffic data or determined traffic jam probabilities) received from other vehicles or from infrastructure, and the system may provide an operator of the vehicle advanced warning of a probability of an upcoming traffic jam based at least in part on information received from the other vehicle or vehicles or infrastructure (and optionally the equipped vehicle may be autonomously controlled to maneuver toward and into the particular traffic lane that has a lower determined traffic jam probability ahead of the equipped vehicle).

For autonomous vehicles suitable for deployment with the system of the present invention, an occupant of the vehicle may, under particular circumstances, be desired or required to take over operation/control of the vehicle and drive the vehicle so as to avoid potential hazard for as long as the autonomous system relinquishes such control or driving. Such occupant of the vehicle thus becomes the driver of the autonomous vehicle. As used herein, the term “driver” refers to such an occupant, even when that occupant is not actually driving the vehicle, but is situated in the vehicle so as to be able to take over control and function as the driver of the vehicle when the vehicle control system hands over control to the occupant or driver or when the vehicle control system is not operating in an autonomous or semi-autonomous mode.

Typically an autonomous vehicle would be equipped with a suite of sensors, including multiple machine vision cameras deployed at the front, sides and rear of the vehicle, multiple radar sensors deployed at the front, sides and rear of the vehicle, and/or multiple lidar sensors deployed at the front, sides and rear of the vehicle. Typically, such an autonomous vehicle will also have wireless two way communication with other vehicles or infrastructure, such as via a car2car (V2V) or car2x communication system.

The camera or sensor may comprise any suitable camera or sensor. Optionally, the camera may comprise a “smart camera” that includes the imaging sensor array and associated circuitry and image processing circuitry and electrical connectors and the like as part of a camera module, such as by utilizing aspects of the vision systems described in International Publication Nos. WO 2013/081984 and/or WO 2013/081985, which are hereby incorporated herein by reference in their entireties.

The system may include an image processor operable to process image data captured by the camera or cameras, such as for detecting objects or other vehicles or pedestrians or the like in the field of view of one or more of the cameras. For example, the image processor may comprise an image processing chip selected from the EYEQ family of image processing chips available from Mobileye Vision Technologies Ltd. of Jerusalem, Israel, and may include object detection software (such as the types described in U.S. Pat. Nos. 7,855,755; 7,720,580 and/or 7,038,577, which are hereby incorporated herein by reference in their entireties), and may analyze image data to detect vehicles and/or other objects. Responsive to such image processing, and when an object or other vehicle is detected, the system may generate an alert to the driver of the vehicle and/or may generate an overlay at the displayed image to highlight or enhance display of the detected object or vehicle, in order to enhance the driver's awareness of the detected object or vehicle or hazardous condition during a driving maneuver of the equipped vehicle.

The vehicle may include any type of sensor or sensors, such as imaging sensors or radar sensors or lidar sensors or ultrasonic sensors or the like. The imaging sensor or camera may capture image data for image processing and may comprise any suitable camera or sensing device, such as, for example, a two dimensional array of a plurality of photosensor elements arranged in at least 640 columns and 480 rows (at least a 640×480 imaging array, such as a megapixel imaging array or the like), with a respective lens focusing images onto respective portions of the array. The photosensor array may comprise a plurality of photosensor elements arranged in a photosensor array having rows and columns. Preferably, the imaging array has at least 300,000 photosensor elements or pixels, more preferably at least 500,000 photosensor elements or pixels and more preferably at least 1 million photosensor elements or pixels. The imaging array may capture color image data, such as via spectral filtering at the array, such as via an RGB (red, green and blue) filter or via a red/red complement filter or such as via an RCC (red, clear, clear) filter or the like. The logic and control circuit of the imaging sensor may function in any known manner, and the image processing and algorithmic processing may comprise any suitable means for processing the images and/or image data.

Optionally, the camera may comprise a forward viewing camera, such as disposed at a windshield electronics module (WEM) or the like. The forward viewing camera may utilize aspects of the systems described in U.S. Pat. Nos. 9,896,039; 9,871,971; 9,596,387; 9,487,159; 8,256,821; 7,480,149; 6,824,281 and/or 6,690,268, and/or U.S. Publication Nos. US-2015-0327398; US-2015-0015713; US-2014-0160284; US-2014-0226012 and/or US-2009-0295181, which are all hereby incorporated herein by reference in their entireties.

The system may utilize sensors, such as radar or lidar sensors or the like. The sensing system may utilize aspects of the systems described in U.S. Pat. Nos. 9,753,121; 9,689,967; 9,599,702; 9,575,160; 9,146,898; 9,036,026; 8,027,029; 8,013,780; 6,825,455; 7,053,357; 7,408,627; 7,405,812; 7,379,163; 7,379,100; 7,375,803; 7,352,454; 7,340,077; 7,321, 111; 7,310,431; 7,283,213; 7,212,663; 7,203,356; 7,176,438; 7,157,685; 6,919,549; 6,906,793; 6,876,775; 6,710,770; 6,690,354; 6,678,039; 6,674,895 and/or 6,587,186, and/or International Publication Nos. WO 2018/007995 and/or WO 2011/090484, and/or U.S. Publication Nos. US-2018-0231635; US-2018-0045812; US-2018-0015875; US-2017-0356994; US-2017-0315231; US-2017-0276788; US-2017-0254873; US-2017-0222311 and/or US-2010-0245066, which are hereby incorporated herein by reference in their entireties.

The system may also communicate with other systems, such as via a vehicle-to-vehicle communication system or a vehicle-to-infrastructure communication system or the like. Such car2car or vehicle to vehicle (V2V) and vehicle-to-infrastructure (car2X or V2X or V21 or a 4G or 5G broadband cellular network) technology provides for communication between vehicles and/or infrastructure based on information provided by one or more vehicles and/or information provided by a remote server or the like. Such vehicle communication systems may utilize aspects of the systems described in U.S. Pat. Nos. 6,690,268; 6,693,517 and/or 7,580,795, and/or U.S. Publication Nos. US-2014-0375476; US-2014-0218529; US-2013-0222592; US-2012-0218412; US-2012-0062743; US-2015-0251599; US-2015-0158499; US-2015-0124096; US-2015-0352953; US-2016-0036917 and/or US-2016-0210853, which are hereby incorporated herein by reference in their entireties.

Changes and modifications in the specifically described embodiments can be carried out without departing from the principles of the invention, which is intended to be limited only by the scope of the appended claims, as interpreted according to the principles of patent law including the doctrine of equivalents.

1. A vehicular driving assist system, the vehicular driving assist system comprising:
a forward-viewing camera disposed at a vehicle equipped with the vehicular driving assist system, wherein the forward-viewing camera is disposed at an in-cabin side of a windshield of the equipped vehicle and views at least forward of the equipped vehicle through the windshield, and wherein the forward-viewing camera is operable to capture image data;
an electronic control unit (ECU) comprising electronic circuitry and associated software;
wherein image data captured by the forward-viewing camera is transferred to the ECU;
wherein the electronic circuitry of the ECU processes image data captured by the forward-viewing camera and transferred to the ECU;
wherein, with the equipped vehicle traveling along a traffic lane of a multi-lane road, the vehicular driving assist system, based at least in part on processing at the ECU of image data captured by the forward-viewing camera and transferred to the ECU, determines traffic attributes for (i) the traffic lane along which the equipped vehicle is traveling and (ii) at least one adjacent traffic lane of the multi-lane road that is adjacent to the traffic lane along which the equipped vehicle is traveling and that has traffic traveling in the same direction as the equipped vehicle is traveling;
wherein the vehicular driving assist system determines traffic jam probability for each respective traffic lane of the multi-lane road based at least in part on the determined traffic attributes; and
wherein, based on the determined traffic jam probability for each respective traffic lane of the multi-lane road, the traffic lane that has the lowest determined respective traffic jam probability is determined.

2. The vehicular driving assist system of claim 1, wherein the traffic attributes comprise at least one selected from the group consisting of (i) traffic density, (ii) traffic flow rate, (iii) traffic collective velocity and (iv) traffic normalized longitudinal distance.

3. The vehicular driving assist system of claim 1, wherein the vehicular driving assist system, based at least in part on the determined traffic jam probability for each respective traffic lane, determines an overall traffic jam probability for the multi-lane road.

4. The vehicular driving assist system of claim 3, wherein the vehicular driving assist system determines the overall traffic jam probability based on an average of the determined traffic jam probability for each respective traffic lane of the multi-lane road.

5. The vehicular driving assist system of claim 1, wherein the vehicular driving assist system determines traffic jam probability for each respective traffic lane based in part on wireless communication to the equipped vehicle from a source that is remote from the equipped vehicle.

6. The vehicular driving assist system of claim 5, wherein the wireless communication comprises at least one selected from the group consisting of (i) vehicle-to-vehicle communication from another vehicle traveling along the multi-lane road and (ii) vehicle-to-infrastructure communication from infrastructure.

7. The vehicular driving assist system of claim 1, wherein the vehicular driving assist system determines traffic jam probability for each respective traffic lane based in part on traffic normalized longitudinal distance.

8. The vehicular driving assist system of claim 1, wherein a driver of the equipped vehicle is notified of the determined traffic lane that has the lowest determined respective traffic jam probability.

9. The vehicular driving assist system of claim 1, wherein the equipped vehicle travels along the determined traffic lane that has the lowest determined respective traffic jam probability.

10. The vehicular driving assist system of claim 1, wherein image data captured by the forward-viewing camera is processed at the ECU for at least one selected from the group consisting of (i) a traffic sign recognition system of the equipped vehicle, (ii) a headlamp control system of the equipped vehicle, (iii) a pedestrian detection system of the equipped vehicle, (iv) a collision avoidance system of the equipped vehicle, (v) a lane marker detection system of the equipped vehicle, (vi) an adaptive cruise control system of the equipped vehicle and (vii) a lane keep assist system of the equipped vehicle.

11. The vehicular driving assist system of claim 1, wherein the forward-viewing camera comprises an imaging array having at least one million photosensors arranged in rows and columns.

12. The vehicular driving assist system of claim 1, wherein, with the equipped vehicle traveling along the traffic lane of the multi-lane road, the vehicular driving assist system determines traffic attributes based in part on processing at the ECU of sensor data captured by at least one forward-sensing radar sensor of the equipped vehicle.

13. The vehicular driving assist system of claim 1, wherein, with the equipped vehicle traveling along the traffic lane of the multi-lane road, the vehicular driving assist system determines traffic attributes based in part on processing at the ECU of sensor data captured by at least one forward-sensing lidar sensor of the equipped vehicle.

14. The vehicular driving assist system of claim 1, wherein the vehicular driving assist system predicts a traffic value based at least in part on the determined traffic attributes, and wherein the vehicular driving assist system determines traffic jam probability for each respective traffic lane of the multi-lane road based in part on the predicted traffic value.

15. The vehicular driving assist system of claim 14, wherein the vehicular driving assist system predicts the traffic value based in part on an output from a traffic prediction model.

16. The vehicular driving assist system of claim 15, wherein the traffic prediction model comprises a trained linear regression prediction model.

17. The vehicular driving assist system of claim 15, wherein the traffic prediction model is trained on annotated data, and wherein the annotated data is categorized into traffic scenarios.

18. The vehicular driving assist system of claim 17, wherein the traffic scenarios comprise at least two selected from the group consisting of (i) no traffic, (ii) slow moving traffic, (iii) stop and go traffic and (iv) stopped traffic.

19. The vehicular driving assist system of claim 17, wherein the annotated data comprises subjective observations from at least one traffic observer.

20. The vehicular driving assist system of claim 15, wherein the ECU performs data transformation on the output from the traffic prediction model, and wherein the data transformation comprises a multi-variable quadratic linear equation.

21. The vehicular driving assist system of claim 20, wherein the multi-variable quadratic linear equation comprises a three variable quadratic linear equation.

22. The vehicular driving assist system of claim 15, wherein the traffic prediction model is trained with weight least square fitting using an orthogonal-triangular decomposition algorithm.

23. The vehicular driving assist system of claim 1, wherein image data captured by the forward-viewing camera and transferred to the ECU is processed at the ECU by an image processor.

24. The vehicular driving assist system of claim 23, wherein image data captured by the forward-viewing camera and transferred to the ECU is processed at the ECU at least in part by the image processor for a driver assistance system of the equipped vehicle.

25. The vehicular driving assist system of claim 24, wherein the driver assistance system of the equipped vehicle comprises an adaptive cruise control (ACC) system of the equipped vehicle.

26. The vehicular driving assist system of claim 24, wherein the driver assistance system of the equipped vehicle comprises a lane keep system of the equipped vehicle.

27. The vehicular driving assist system of claim 24, wherein the image processor comprises an image processing chip.

28. The vehicular driving assist system of claim 27, wherein image data captured by the forward-viewing camera and transferred to the ECU is processed at the ECU by the image processing chip for at least one selected from the group consisting of (i) at traffic sign recognition system of the equipped vehicle, (ii) a headlamp control system of the equipped vehicle, (iii) a pedestrian detection system of the equipped vehicle, (iv) a collision avoidance system of the equipped vehicle and (v) a lane marker detection system of the equipped vehicle.

29. The vehicular driving assist system of claim 1, wherein determination based at least in part on the determined traffic attributes of traffic jam probability for each respective traffic lane of the multi-lane road comprises determination of likelihood of greater traffic density for each respective traffic lane of the multi-lane road.

30. The vehicular driving assist system of claim 1, wherein determination based at least in part on the determined traffic attributes of traffic jam probability for each respective traffic lane of the multi-lane road comprises determination of likelihood of slow-moving traffic for each respective traffic lane of the multi-lane road.

31. The vehicular driving assist system of claim 1, wherein determination based at least in part on the determined traffic attributes of traffic jam probability for each respective traffic lane of the multi-lane road comprises determination of likelihood of stopped traffic for each respective traffic lane of the multi-lane road.

32. The vehicular driving assist system of claim 1, wherein determination based at least in part on the determined traffic attributes of traffic jam probability for each respective traffic lane of the multi-lane road is used to select a traffic lane of the multi-lane road for the equipped vehicle to travel along.

33. The vehicular driving assist system of claim 1, wherein the equipped vehicle comprises a suite of sensors, the suite of sensors comprising the forward-viewing camera disposed at the in-cabin side of the windshield of the equipped vehicle and further comprising other cameras viewing exterior of the equipped vehicle that are deployed at the sides and rear of the equipped vehicle, and wherein, with the equipped vehicle traveling along the traffic lane of the multi-lane road, the vehicular driving assist system determines traffic attributes based in part on processing at the ECU of image data captured by at least one of the other cameras viewing exterior of the equipped vehicle that are deployed at the sides and rear of the equipped vehicle.

34. The vehicular driving assist system of claim 1, wherein the equipped vehicle comprises a suite of sensors, the suite of sensors comprising the forward-viewing camera disposed at the in-cabin side of the windshield of the equipped vehicle and further comprising radar sensors sensing exterior of the equipped vehicle that are deployed at the front and sides of the equipped vehicle, and wherein, with the equipped vehicle traveling along the traffic lane of the multi-lane road, the vehicular driving assist system determines traffic attributes based in part on processing at the ECU of radar data captured by at least one of the radar sensors sensing exterior of the equipped vehicle that are deployed at the front and sides of the equipped vehicle.

35. A vehicular driving assist system, the vehicular driving assist system comprising:
a forward-viewing camera disposed at a vehicle equipped with the vehicular driving assist system, wherein the forward-viewing camera is disposed at an in-cabin side of a windshield of the equipped vehicle and views at least forward of the equipped vehicle through the windshield, and wherein the forward-viewing camera is operable to capture image data;
wherein the forward-viewing camera comprises an imaging array having at least one million photosensors arranged in rows and columns;
an electronic control unit (ECU) comprising electronic circuitry and associated software;
wherein image data captured by the forward-viewing camera is transferred to the ECU;
wherein the electronic circuitry of the ECU processes image data captured by the forward-viewing camera and transferred to the ECU;
wherein, with the equipped vehicle traveling along a traffic lane of a multi-lane road, the vehicular driving assist system, based at least in part on processing at the ECU of image data captured by the forward-viewing camera and transferred to the ECU, determines traffic attributes for (i) the traffic lane along which the equipped vehicle is traveling and (ii) at least one adjacent traffic lane of the multi-lane road that is adjacent to the traffic lane along which the equipped vehicle is traveling and that has traffic traveling in the same direction as the equipped vehicle is traveling;
wherein the vehicular driving assist system determines traffic jam probability for each respective traffic lane of the multi-lane road based at least in part on the determined traffic attributes; and
wherein determination based at least in part on the determined traffic attributes of traffic jam probability for each respective traffic lane of the multi-lane road is used to select a traffic lane of the multi-lane road for the equipped vehicle to travel along.

36. The vehicular driving assist system of claim 35, wherein the traffic attributes comprise at least one selected from the group consisting of (i) traffic density, (ii) traffic flow rate, (iii) traffic collective velocity and (iv) traffic normalized longitudinal distance.

37. The vehicular driving assist system of claim 35, wherein the vehicular driving assist system, based at least in part on the determined traffic jam probability for each respective traffic lane, determines an overall traffic jam probability for the multi-lane road.

38. The vehicular driving assist system of claim 37, wherein the vehicular driving assist system determines the overall traffic jam probability based on an average of the determined traffic jam probability for each respective traffic lane of the multi-lane road.

39. The vehicular driving assist system of claim 35, wherein the vehicular driving assist system determines traffic jam probability for each respective traffic lane based in part on wireless communication to the equipped vehicle from a source that is remote from the equipped vehicle.

40. The vehicular driving assist system of claim 39, wherein the wireless communication comprises at least one selected from the group consisting of (i) vehicle-to-vehicle communication from another vehicle traveling along the multi-lane road and (ii) vehicle-to-infrastructure communication from infrastructure.

41. The vehicular driving assist system of claim 35, wherein, based on the determined traffic jam probability for each respective traffic lane of the multi-lane road, the traffic lane that has the lowest determined respective traffic jam probability is determined.

42. The vehicular driving assist system of claim 41, wherein a driver of the equipped vehicle is notified of the determined traffic lane that has the lowest determined respective traffic jam probability.

43. The vehicular driving assist system of claim 41, wherein the equipped vehicle travels along the determined traffic lane that has the lowest determined respective traffic jam probability.

44. The vehicular driving assist system of claim 35, wherein image data captured by the forward-viewing camera is processed at the ECU for at least one selected from the group consisting of (i) a traffic sign recognition system of the equipped vehicle, (ii) a headlamp control system of the equipped vehicle, (iii) a pedestrian detection system of the equipped vehicle, (iv) a collision avoidance system of the equipped vehicle, (v) a lane marker detection system of the equipped vehicle, (vi) an adaptive cruise control system of the equipped vehicle and (vii) a lane keep assist system of the equipped vehicle.

45. The vehicular driving assist system of claim 35, wherein, with the equipped vehicle traveling along the traffic lane of the multi-lane road, the vehicular driving assist system determines traffic attributes based in part on processing at the ECU of sensor data captured by at least one forward-sensing radar sensor of the equipped vehicle.

46. The vehicular driving assist system of claim 35, wherein, with the equipped vehicle traveling along the traffic lane of the multi-lane road, the vehicular driving assist system determines traffic attributes based in part on processing at the ECU of sensor data captured by at least one forward-sensing lidar sensor of the equipped vehicle.

47. The vehicular driving assist system of claim 35, wherein the vehicular driving assist system predicts a traffic value based at least in part on the determined traffic attributes, and wherein the vehicular driving assist system determines traffic jam probability for each respective traffic lane of the multi-lane road based in part on the predicted traffic value.

48. The vehicular driving assist system of claim 47, wherein the vehicular driving assist system predicts the traffic value based in part on an output from a traffic prediction model.

49. The vehicular driving assist system of claim 35, wherein image data captured by the forward-viewing camera and transferred to the ECU is processed at the ECU by an image processor.

50. The vehicular driving assist system of claim 49, wherein image data captured by the forward-viewing camera and transferred to the ECU is processed at the ECU at least in part by the image processor for a driver assistance system of the equipped vehicle.

51. The vehicular driving assist system of claim 50, wherein the driver assistance system of the equipped vehicle comprises an adaptive cruise control (ACC) system of the equipped vehicle.

52. The vehicular driving assist system of claim 50, wherein the driver assistance system of the equipped vehicle comprises a lane keep system of the equipped vehicle.

53. The vehicular driving assist system of claim 50, wherein the image processor comprises an image processing chip.

54. The vehicular driving assist system of claim 53, wherein image data captured by the forward-viewing camera and transferred to the ECU is processed at the ECU by the image processing chip for at least one selected from the group consisting of (i) at traffic sign recognition system of the equipped vehicle, (ii) a headlamp control system of the equipped vehicle, (iii) a pedestrian detection system of the equipped vehicle, (iv) a collision avoidance system of the equipped vehicle and (v) a lane marker detection system of the equipped vehicle.

55. The vehicular driving assist system of claim 35, wherein determination based at least in part on the determined traffic attributes of traffic jam probability for each respective traffic lane of the multi-lane road comprises determination of likelihood of greater traffic density for each respective traffic lane of the multi-lane road.

56. The vehicular driving assist system of claim 35, wherein determination based at least in part on the determined traffic attributes of traffic jam probability for each respective traffic lane of the multi-lane road comprises determination of likelihood of slow-moving traffic for each respective traffic lane of the multi-lane road.

57. The vehicular driving assist system of claim 35, wherein determination based at least in part on the determined traffic attributes of traffic jam probability for each respective traffic lane of the multi-lane road comprises determination of likelihood of stopped traffic for each respective traffic lane of the multi-lane road.

58. The vehicular driving assist system of claim 35, wherein the equipped vehicle comprises a suite of sensors, the suite of sensors comprising the forward-viewing camera disposed at the in-cabin side of the windshield of the equipped vehicle and further comprising other cameras viewing exterior of the equipped vehicle that are deployed at the sides and rear of the equipped vehicle, and wherein, with the equipped vehicle traveling along the traffic lane of the multi-lane road, the vehicular driving assist system determines traffic attributes based in part on processing at the ECU of image data captured by at least one of the other cameras viewing exterior of the equipped vehicle that are deployed at the sides and rear of the equipped vehicle.

59. The vehicular driving assist system of claim 35, wherein the equipped vehicle comprises a suite of sensors, the suite of sensors comprising the forward-viewing camera disposed at the in-cabin side of the windshield of the equipped vehicle and further comprising radar sensors sensing exterior of the equipped vehicle that are deployed at the front and sides of the equipped vehicle, and wherein, with the equipped vehicle traveling along the traffic lane of the multi-lane road, the vehicular driving assist system determines traffic attributes based in part on processing at the ECU of radar data captured by at least one of the radar sensors sensing exterior of the equipped vehicle that are deployed at the front and sides of the equipped vehicle.

60. A vehicular driving assist system, the vehicular driving assist system comprising:
a forward-viewing camera disposed at a vehicle equipped with the vehicular driving assist system, wherein the forward-viewing camera is disposed at an in-cabin side of a windshield of the equipped vehicle and views at least forward of the equipped vehicle through the windshield, and wherein the forward-viewing camera is operable to capture image data;
wherein the forward-viewing camera comprises an imaging array having at least one million photosensors arranged in rows and columns;
an electronic control unit (ECU) comprising electronic circuitry and associated software;
wherein image data captured by the forward-viewing camera is transferred to the ECU;
wherein the electronic circuitry of the ECU processes image data captured by the forward-viewing camera and transferred to the ECU;
wherein, with the equipped vehicle traveling along a traffic lane of a multi-lane road, the vehicular driving assist system, based at least in part on processing at the ECU of image data captured by the forward-viewing camera and transferred to the ECU, determines traffic attributes for (i) the traffic lane along which the equipped vehicle is traveling and (ii) at least one adjacent traffic lane of the multi-lane road that is adjacent to the traffic lane along which the equipped vehicle is traveling and that has traffic traveling in the same direction as the equipped vehicle is traveling;
wherein the vehicular driving assist system determines traffic jam probability for each respective traffic lane of the multi-lane road based at least in part on the determined traffic attributes; and
wherein image data captured by the forward-viewing camera and transferred to the ECU is processed at the ECU by an image processor for a driver assistance system of the equipped vehicle.

61. The vehicular driving assist system of claim 60, wherein the traffic attributes comprise at least one selected from the group consisting of (i) traffic density, (ii) traffic flow rate, (iii) traffic collective velocity and (iv) traffic normalized longitudinal distance.

62. The vehicular driving assist system of claim 60, wherein the vehicular driving assist system, based at least in part on the determined traffic jam probability for each respective traffic lane, determines an overall traffic jam probability for the multi-lane road.

63. The vehicular driving assist system of claim 62, wherein the vehicular driving assist system determines the overall traffic jam probability based on an average of the determined traffic jam probability for each respective traffic lane of the multi-lane road.

64. The vehicular driving assist system of claim 60, wherein the vehicular driving assist system determines traffic jam probability for each respective traffic lane based in part on wireless communication to the equipped vehicle from a source that is remote from the equipped vehicle.

65. The vehicular driving assist system of claim 64, wherein the wireless communication comprises at least one selected from the group consisting of (i) vehicle-to-vehicle communication from another vehicle traveling along the multi-lane road and (ii) vehicle-to-infrastructure communication from infrastructure.

66. The vehicular driving assist system of claim 60, wherein, based on the determined traffic jam probability for each respective traffic lane of the multi-lane road, the traffic lane that has the lowest determined respective traffic jam probability is determined.

67. The vehicular driving assist system of claim 66, wherein a driver of the equipped vehicle is notified of the determined traffic lane that has the lowest determined respective traffic jam probability.

68. The vehicular driving assist system of claim 66, wherein the equipped vehicle travels along the determined traffic lane that has the lowest determined respective traffic jam probability.

69. The vehicular driving assist system of claim 60, wherein the driver assistance system of the equipped vehicle comprises at least one selected from the group consisting of (i) a traffic sign recognition system of the equipped vehicle, (ii) a headlamp control system of the equipped vehicle, (iii) a pedestrian detection system of the equipped vehicle, (iv) a collision avoidance system of the equipped vehicle, (v) a lane marker detection system of the equipped vehicle, (vi) an adaptive cruise control system of the equipped vehicle and (vii) a lane keep assist system of the equipped vehicle.

70. The vehicular driving assist system of claim 60, wherein, with the equipped vehicle traveling along the traffic lane of the multi-lane road, the vehicular driving assist system determines traffic attributes based in part on processing at the ECU of sensor data captured by at least one forward-sensing radar sensor of the equipped vehicle.

71. The vehicular driving assist system of claim 60, wherein, with the equipped vehicle traveling along the traffic lane of the multi-lane road, the vehicular driving assist system determines traffic attributes based in part on processing at the ECU of sensor data captured by at least one forward-sensing lidar sensor of the equipped vehicle.

72. The vehicular driving assist system of claim 60, wherein the vehicular driving assist system predicts a traffic value based at least in part on the determined traffic attributes, and wherein the vehicular driving assist system determines traffic jam probability for each respective traffic lane of the multi-lane road based in part on the predicted traffic value.

73. The vehicular driving assist system of claim 72, wherein the vehicular driving assist system predicts the traffic value based in part on an output from a traffic prediction model.

74. The vehicular driving assist system of claim 60, wherein the driver assistance system of the equipped vehicle comprises an adaptive cruise control (ACC) system of the equipped vehicle.

75. The vehicular driving assist system of claim 60, wherein the driver assistance system of the equipped vehicle comprises a lane keep system of the equipped vehicle.

76. The vehicular driving assist system of claim 60, wherein the image processor comprises an image processing chip.

77. The vehicular driving assist system of claim 76, wherein image data captured by the forward-viewing camera and transferred to the ECU is processed at the ECU by the image processing chip for at least one selected from the group consisting of (i) at traffic sign recognition system of the equipped vehicle, (ii) a headlamp control system of the equipped vehicle, (iii) a pedestrian detection system of the equipped vehicle, (iv) a collision avoidance system of the equipped vehicle and (v) a lane marker detection system of the equipped vehicle.

78. The vehicular driving assist system of claim 60, wherein determination based at least in part on the determined traffic attributes of traffic jam probability for each respective traffic lane of the multi-lane road comprises determination of likelihood of greater traffic density for each respective traffic lane of the multi-lane road.

79. The vehicular driving assist system of claim 60, wherein determination based at least in part on the determined traffic attributes of traffic jam probability for each respective traffic lane of the multi-lane road comprises determination of likelihood of slow-moving traffic for each respective traffic lane of the multi-lane road.

80. The vehicular driving assist system of claim 60, wherein determination based at least in part on the determined traffic attributes of traffic jam probability for each respective traffic lane of the multi-lane road comprises determination of likelihood of stopped traffic for each respective traffic lane of the multi-lane road.

81. The vehicular driving assist system of claim 60, wherein the equipped vehicle comprises a suite of sensors, the suite of sensors comprising the forward-viewing camera disposed at the in-cabin side of the windshield of the equipped vehicle and further comprising other cameras viewing exterior of the equipped vehicle that are deployed at the sides and rear of the equipped vehicle, and wherein, with the equipped vehicle traveling along the traffic lane of the multi-lane road, the vehicular driving assist system determines traffic attributes based in part on processing at the ECU of image data captured by at least one of the other cameras viewing exterior of the equipped vehicle that are deployed at the sides and rear of the equipped vehicle.

82. The vehicular driving assist system of claim 60, wherein the equipped vehicle comprises a suite of sensors, the suite of sensors comprising the forward-viewing camera disposed at the in-cabin side of the windshield of the equipped vehicle and further comprising radar sensors sensing exterior of the equipped vehicle that are deployed at the front and sides of the equipped vehicle, and wherein, with the equipped vehicle traveling along the traffic lane of the multi-lane road, the vehicular driving assist system determines traffic attributes based in part on processing at the ECU of radar data captured by at least one of the radar sensors sensing exterior of the equipped vehicle that are deployed at the front and sides of the equipped vehicle.
